(19) United States
(12) Patent Application Publication
(10) Pub. No.: US 2025/0305090 A1
(43) Pub. Date: Oct. 2, 2025

(54) SEPARATION OF CRITICAL BATTERY MATERIALS FROM END-OF-LIFE SOURCES

(71) Applicant: UT-Battelle, LLC, Oak Ridge, TN (US)

(72) Inventors: Ramesh R. Bhave, Knoxville, TN (US); Priyesh A. Wagh, Strongsville, OH (US); Syed Z. Islam, Oak Ridge, TN (US)

(21) Appl. No.: 19/083,978

(22) Filed: Mar. 19, 2025

Related U.S. Application Data
(60) Provisional application No. 63/570,499, filed on Mar. 27, 2024.

(51) Int. Cl. C22B 26/12; B01D 61/24; B01D 61/28; B01D 63/02; B01D 69/02; C22B 3/00; C22B 3/02; C22B 3/24; C22B 7/00; C22B 15/00; C22B 21/00; C22B 47/00; H01M 10/54

(52) U.S. Cl. CPC C22B 26/12; B01D 61/246; B01D 61/28; B01D 63/02; B01D 69/02; C22B 3/02; C22B 3/24; C22B 7/007; C22B 15/0071; C22B 15/0086; C22B 21/0023; C22B 23/043; C22B 47/00; H01M 10/54; B01D 2325/02833; B01D 2325/02834

(57) ABSTRACT

The present invention provides a scalable method for recycling end-of-life lithium-ion batteries by selectively extracting and recovering valuable metals. The method includes dissolving battery cathode material in acid to create a feed solution. The method further includes pre-wetting the porous sidewalls of a hollow fiber membrane module with an organic solvent and an extractant, for example di-(2-ethylhexyl)phosphoric acid. During the extraction process, the feed solution flows along one side of the hollow fibers, while a strip solution moves along the opposite side of the hollow fibers. To optimize separation, the pH of the feed solution is maintained between 2.5 and 3.0, while the acid concentration of the strip solution is maintained between 0.5M and 3.0M. The extractant continuously and selectively removes aluminum, copper, and other metals from the feed solution, while preventing the extraction of lithium, cobalt, and nickel.

### CROSS-REFERENCE TO RELATED APPLICATIONS

This application claims the benefit of U.S. Provisional Application 63/570,499, filed Mar. 27, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### BACKGROUND OF THE INVENTION

Lithium-ion batteries are widely used for various energy storage applications, ranging from consumer electronics to national defense. In recent years, the popularity of hybrid vehicles and battery electric vehicles has led to significant growth in the demand for lithium-ion batteries. Cobalt, nickel, and lithium are especially important in the manufacture of lithium-ion batteries, but their limited domestic supply presents significant supply chain challenges in the U.S.

The widespread application of lithium-ion batteries is expected to generate millions of tons of end-of-life lithium-ion batteries. Over five million metric tones of lithium-ion batteries are expected to reach end-of-life by 2030, which raises serious environmental concerns. These scrap batteries could provide a secondary source of critical elements with cost-effective recovery and recycling. However, because the industry lacks a clear path to large scale recycling, there are no established technologies for lithium-ion recycling and reuse.

To meet the demands of individual constituent elements for lithium-ion battery manufacturing, there remains a continued need for systems and methods for the separation, recovery, and recycling of critical elements from scrap lithium-ion batteries.

### SUMMARY OF THE INVENTION

In one aspect, the present invention provides membrane solvent extraction for the recovery of high purity (99.5 to 99.99% by weight) critical elements from spent lithium-ion battery cathodes. In membrane solvent extraction, critical cathode materials including lithium, cobalt, and nickel are selectively separated from impurities such as aluminum, iron, copper, and zinc by an extractant that is immobilized in a porous membrane. By using hollow fiber modules, membrane solvent extraction provides a compact and modular configuration, achieving high extraction rates for desirable elements with low energy and cost requirements. Additionally, solvent and extractant requirements are low, thus eliminating the need for relatively large inventory as compared to traditional solvent extraction methods, resulting in waste minimization and near-zero discharge.

One embodiment includes a scalable method for the recovery of critical elements from lithium-ion battery black mass. The method includes pre-wetting a hollow fiber membrane module with an organic phase, the organic phase having an organic solvent and an extractant, for example di-(2-ethylhexyl) phosphoric acid (DEHPA), or other extractants such as Cyanex 272. The method includes directing a feed solution along one side (preferably the shell side) of the hollow fibers and simultaneously directing a strip solution along the opposite side (preferably the lumen side) of the hollow fibers. The feed solution includes lithium-ion battery cathode black mass dissolved in acid, but other source materials can be used in other embodiments. To optimize separation, the pH of the feed solution is maintained between 2.5 and 3.0, while the acid concentration of the strip solution is maintained between 0.5M and 3.0M. The DEHPA extractant continuously and selectively removes impurities such as aluminum, iron, copper, and zinc. The retentate possesses high purity lithium, cobalt, and nickel for further processing and recovery.

In another embodiment, a system is provided. The system includes a membrane module, a feed reservoir, and a strip reservoir. The membrane module includes a plurality of hollow fibers, and the pores of the hollow fibers are wetted (pre-impregnated) with an immobilized organic phase. The organic phase includes a DEHPA extractant and an organic solvent, optionally a synthetic isoparaffinic hydrocarbon solvent. The feed reservoir and the strip reservoir include an aqueous feed solution and a strip solution, respectively, which are in continuous recirculation through the membrane module. The aqueous feed solution is directed along the lumen side of the hollow fibers and the strip solution is directed along the shell side of the hollow fibers, optionally in transverse flow directions. In other embodiments, the aqueous feed solution is directed along the shell side of the hollow fibers and the strip solution is directed along the lumen side of the hollow fibers. The aqueous feed solution includes dissolved black mass containing critical elements, such as lithium, cobalt, and nickel, and undesired elements, such as aluminum, iron, copper, and zinc. The extractant is selected to continuously extract aluminum, iron, copper, and zinc from the aqueous feed solution for recovery by the strip solution.

In these and other embodiments, the retentate is rich in lithium, cobalt, and nickel.

Cobalt can be separated from lithium and nickel in a second stage membrane solvent extraction using Cyanex 272 as the extractant, leaving lithium and nickel in the retentate. A third stage membrane solvent extraction using Cyanex 272 as the extractant can separate nickel (permeate or lumen side) and lithium (retentate or shell side). In other words, lithium, nickel, and cobalt can be separated from each other at high purities in a second stage and third stage membrane solvent extraction process, optionally for recycling into newly manufactured lithium-ion battery cathodes.

These and other features and advantages of the present invention will become apparent from the following description of the invention, when viewed in accordance with the accompanying drawings and appended claims.

### BRIEF DESCRIPTION OF THE FIGURES

FIG. 1 illustrates a membrane module in accordance with a system and a method of the present invention.

FIG. 2 is a table illustrating the composition of various black mass feedstocks from recycled lithium-ion battery material.

FIG. 3 illustrates a single-stage membrane solvent extraction system including the membrane module of FIG. 1.

FIG. 4 illustrates of stage 1 separation of impurities from black mass, stage 2 separation of Co from Ni and L, and stage 3 separation of Ni from Li.

FIG. 5 illustrates the concentration of constituent elements in the feed solution (left) and the strip solution (right) in accordance with a laboratory example.

### DETAILED DESCRIPTION OF THE CURRENT EMBODIMENTS

The invention as contemplated and disclosed herein includes methods and systems for the recovery of critical elements from recycled feedstock, for example lithium-ion battery cathode black mass, through membrane assisted solvent extraction. In general terms, the method include the following steps: a) providing a membrane module including a plurality of porous hollow fibers, b) wetting the plurality of porous hollow fibers with an organic phase including an organic solvent and a DEHPA extractant, c) applying a continuous flow rate of an acidic aqueous feed solution, at a pH of 2.5 to 3.0, along the lumen side or the shell side of the plurality of porous hollow fibers, and d) applying a continuous flow rate of an acidic strip solution, at an acid concentration of 0.5M to 3.0M, along the other of the lumen side or the shell side of the plurality of porous hollow fibers. The step of wetting the plurality of porous hollow fibers (step (b)) is performed prior to the steps of applying a flow rate of feed solution and a flow rate of strip solution (steps (c) and (d)). The steps of applying a flow rate of feed solution and a flow rate of strip solution are generally simultaneous. These steps are discussed below in connection with the recovery of critical elements from lithium-ion battery black mass, however other source materials can be use in other embodiments.

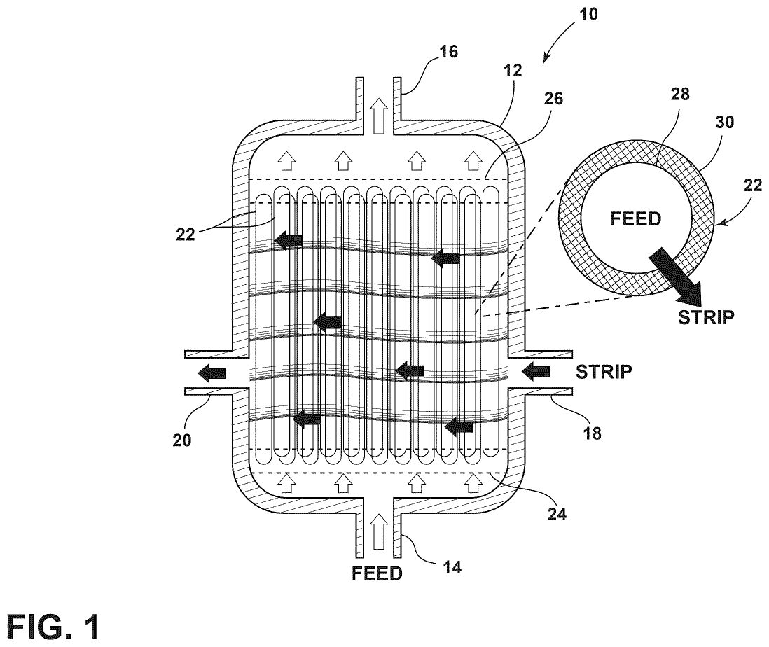

At step (a), providing a membrane module generally includes providing a plurality of hollow or tube-like fibers extending between opposing tubesheets. A membrane module containing a fiber bundle is illustrated in FIG. 1 and generally designated 10. The membrane module 10 includes an outer casing 12 including a feed input port 14, a feed output port 16, a strip input port 18, and a strip output port 20. A suitable membrane module can include a hydrophobic polypropylene membrane module (MicroModule® by Membrana GmbH or MiniModule® by Membrana-Charlotte, LLC) with a membrane module area of 1.4 m². The plurality of hollow fibers 22 are potted to first and second tubesheets 24, 26 at opposing ends thereof, such that the fibers 22 extend in a common direction. Each fiber 22 includes a lumen side 28 and a shell side 30. The lumen side 28 is illustrated in FIG. 1 as being exposed to the feed solution, however in other embodiments the lumen side 28 is exposed to the strip solution. Similarly, the shell side 30 is illustrated in FIG. 1 as being exposed to the strip solution, however in other embodiments the shell side 30 is exposed to the feed solution. As used herein, the “lumen side” includes the interior surface that defines a channel extending longitudinally through the length of the hollow fiber, and the “shell side” includes the exterior surface of the fiber, such that the lumen side and the shell side are spaced apart from each other by the thickness of the membrane sidewall. The side in contact with the feed solution defines the “feed interface,” and the side in contact with the strip solution defines the “strip interface.” The lumen side is the feed interface in some embodiments and is the strip interface in other embodiments. Similarly, the shell side is the strip interface in some embodiments and is the feed interface in other embodiments.

The hollow fibers 22 are porous to retain an organic phase therein and are formed of a material that can withstand the acidic conditions in the feed solution and the strip solution. The hollow fibers 22 can be formed from a hydrophobic material, for example, polypropylene, polyethylene, polyvinylidene fluoride, polyether ether ketone, polysulfone, or polyethersulfone. The hollow fibers include a mean pore size of less than 0.1 micron in some embodiments, while in other embodiments the mean pore size is between 0.01 micron and 0.1 micron inclusive. The hollow fibers include a mean inner diameter of between 0.1 mm and 1.0 mm inclusive, further optionally between 0.2 mm and 0.3 mm inclusive. The hollow fibers include a mean outer diameter of between 0.1 mm and 1.0 mm inclusive, further optionally between 0.6 mm and 0.7 mm inclusive. The hollow fibers have a mean wall thickness of between 0.01 mm and 0.1 mm inclusive, further optionally between 0.02 mm and 0.03 mm inclusive. The thin wall hollow fiber configuration is helpful to reduce diffusion path length, enhancing separation efficiency.

At step (b), wetting the plurality of porous fibers with an organic phase generally includes directing the organic phase through the feed input port 14 for a predetermined period (e.g., one hour) to saturate the fibers with the organic phase. The flow of organic phase is stopped after a sufficient period has elapsed, resulting in an immobilized organic phase within the pores of the plurality of fibers. The immobilized organic phase includes an extractant and an organic solvent. The extractant can be selected to reject critical elements while forming metal complexes from undesired elements during membrane solvent extraction. In the current embodiment, the extractant includes di-(2-ethylhexyl)phosphoric acid (DEHPA). DEHPA is an acidic extractant capable of forming metal complexes that are more soluble in the organic phase than in water and that can be selectively removed from solutions. The organic solvent includes a synthetic isoparaffinic hydrocarbon solvent, for example Isopar-L (Exxon Mobile Corporation), or kerosene. Other organic solvents can be used in other embodiments where desired. In these and other embodiments, the organic phase includes an extractant and an organic solvent with a volume ratio of 1:1 to 1:4, inclusive. In one embodiment, for example, the organic phase includes 30% by volume of DEHPA (the extractant) and 70% by volume of Isopar-L (the organic solvent).

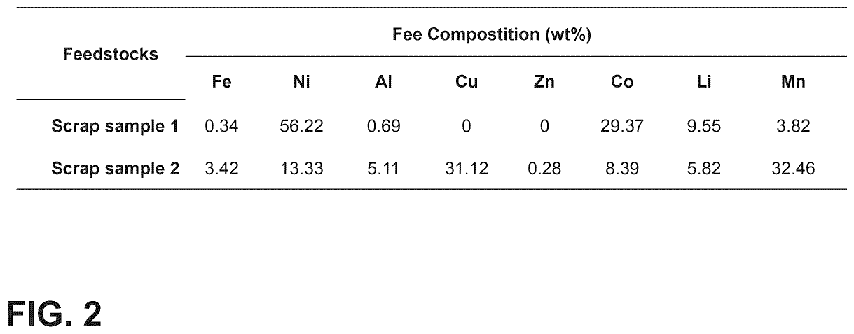

Before continuing with step (c), it should be noted that lithium-ion batteries are typically shredded together at the end of their service life, which results in a black mass containing critical elements, such as cobalt (Co), nickel (Ni), lithium (Li), and manganese (Mn), as well as undesired elements or impurities such as iron (Fe), aluminum (Al), copper (Cu), and zinc (Zn). The non-metals such as carbon binders and graphite are typically removed by filtration from the black mass by leaching the metals in an acid solution. FIG. 2 depicts the metal composition of various industrial scrap lithium-ion battery feedstocks. Scrap sample 1 was pretreated by the recycler to remove some impurities, such as copper. Scrap sample 2 was obtained with no pretreatment and shows an increased presence of impurities. Both scrap samples show a mixture of critical elements (e.g., Ni, Co, Li, and Mn) and impurities (Fe, Zn, Al, Cu). DEHPA was found to selectively extract Fe, Zn, Al, Cu at or below a feed pH of 3.0. Although DEHPA extracts Mn along with other impurities, Mn can be recovered using additional membrane solvent extraction processing steps or other separation methods.

Step (c) includes directing a continuous flow rate of an acidic aqueous feed solution along the lumen side or the shell side of the plurality of porous hollow fibers. As shown in FIG. 1, the feed solution can be directed through the module 10 along the lumen side 28 of each of the plurality of porous hollow fibers 22. Alternatively, the feed solution can be directed through the module 10 along the shell side 30 of each of the plurality of fibers 22. The acidic aqueous feed solution includes dissolved cathode black mass feedstock from post-consumer lithium-ion batteries, for example LiCoO₂ cathode material and LiNiCoMnO₂ (NMC) cathode material. The feed solution has a pH that is selected based on the extractant. For DEHPA, the feed solution can have a pH of 2.5 to 3.0, inclusive, which can be achieved by dissolving the feedstock 0.2 to 4.0 M H₂SO₄. In order to maintain an extraction rate, the pH of the feed solution can be maintained between 2.5 and 3.0 by intermittently adding ammonium hydroxide (or another base such as sodium hydroxide) as needed.

Step (d) includes directing a continuous flow rate of an acidic aqueous strip solution along the lumen side or the shell side of the plurality of permeable fibers for back-extraction. The strip solution as adapted to strip iron (Fe), copper (Cu), zinc (Zn), and manganese (Mn) that have diffused from the feed interface to the strip interface. The strip solution can include H₂SO₄, HNO₃, HCl, or H₃PO₄, for example, such that the acid concentration of the strip solution is maintained between 0.5M and 3.0M. Further by example, the strip solution can include 2.0M H₂SO₄. Still further by example, the pH of the strip solution is maintained between 2.0 and 4.0. The strip solution is directed through the module 10 along the shell side 30 of each of the plurality of fibers 22 as shown in FIG. 1, optionally in a direction generally transverse to the flow of the feed solution within the fibers 22. Alternatively, the strip solution can be directed through the interior of the hollow fibers 22 to contact the lumen side 28 thereof. Steps (c) and (d) can be performed continuously until a concentration of one or more of the undesired metals in the feed solution falls below a predetermined level, for example below 1,000 ppm, further optionally below 500 ppm.

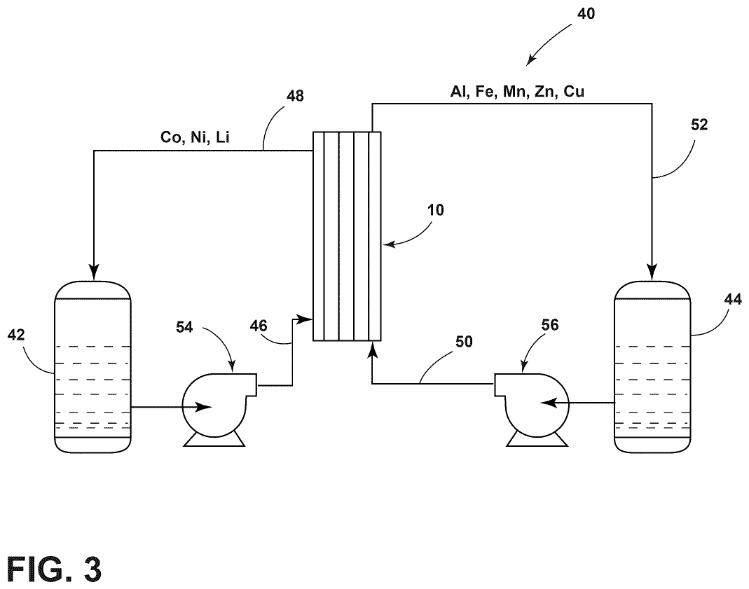

To further illustrate the circulation of the feed solution and the strip solution, a system for membrane assisted solvent extraction is illustrated in FIG. 3 and generally designated 40. The system 40 includes a feed reservoir 42, a strip reservoir 44, a membrane module 10, a feed line 46, a feed return line 48, a strip line 50, and a strip return line 52. The feed solution is contained within the feed reservoir 42 and kept under constant agitation with a mechanical stirrer to ensure a uniform concentration. The feed line 46 includes a pump 54, for example a peristaltic pump or a centrifugal pump, to ensure the feed line pressure is slightly greater than the strip line pressure. The strip line 50 also includes a pump 56, for example a peristaltic pump, to ensure a continuous flow of strip solution through the module 10. The feed solution and the strip solution are in continuous recirculation, while in other embodiments the feed line and/or the strip line form an open circuit.

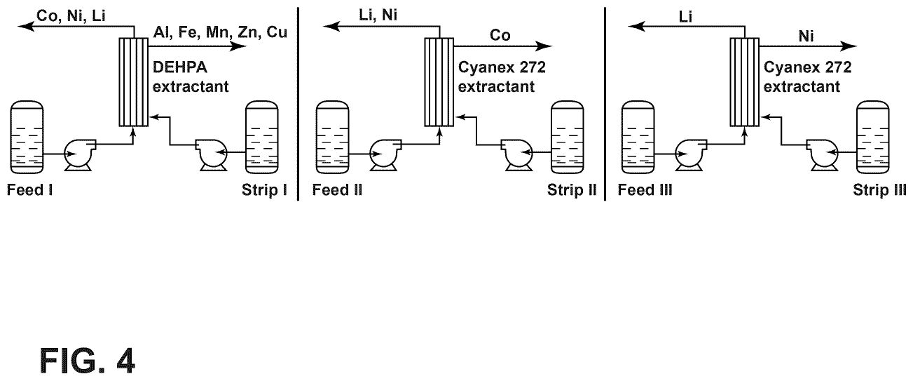

The subsequent separation of lithium, nickel, and cobalt from the feed solution can be performed as set forth in U.S. Pat. No. 11,811,035 to Bhave et al. entitled “Recovery of Critical Elements from End-of-Life Lithium-Ion Batteries with Supported Membrane Solvent Extraction,” the disclosure of which is hereby incorporated by reference in its entirety. As shown in FIG. 4, for example, cobalt can be separated from lithium and nickel in a second stage membrane solvent extraction using Cyanex 272 as the extractant, leaving lithium and nickel in the feed solution. A third stage membrane solvent extraction using Cyanex 272 as the extractant can separate nickel (permeate) and lithium (retentate). In other words, lithium, nickel, and cobalt can be separated from each other at high purities in second stage and third stage membrane solvent extraction processes, optionally for recycling into newly manufactured lithium-ion battery cathodes.

The method and system provide the recovery of substantially pure cobalt, nickel, and lithium as part of a continuous and scalable recovery process. As the immobilized extractant, DEHPA substantially rejected cobalt, nickel, and lithium at the feed interface, while transporting other metals to the strip interface. As used herein, “substantially rejected” means the elemental molarity (moles per liter of solution) of the receiving solution is less than 1% of the elemental molarity (moles per liter of solution) of the donating (e.g., feed) solution for the rejected element after membrane solvent extraction of one hour, unless otherwise stated. The method and system have inherent features that can overcome removal limitations caused by equilibrium effects and can recover critical elements in a highly pure form as demonstrated by the following example, which is intended to be non-limiting.

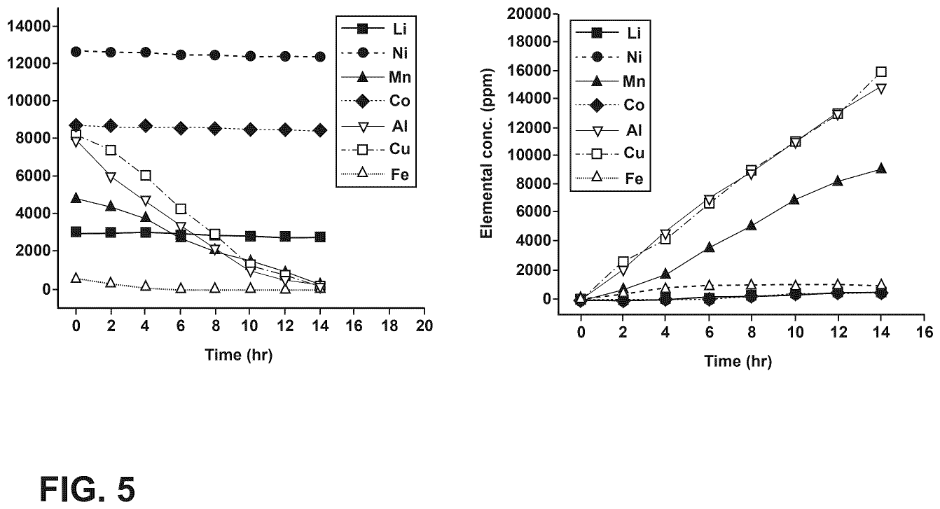

In one example, an aqueous feed solution was prepared by dissolving 60 grams of scrap lithium-ion battery material in 750 mL of 0.5M sulfuric acid (H₂SO₄). Undissolved carbon black was separated from the feed solution using vacuum filtration. In addition, 2 vol. % hydrogen peroxide (H₂O₂) was used as a reducing agent to convert partially reduced Co³⁺ to the soluble Co²⁺ valence state. A buffer solution of 250 mL of 3M sodium acetate (NaC₂H₃O₂) was used to stabilize the pH of the feed solution, yielding a feed solution concentration of approximately 45 g/L of spent cathode material. The extractant used was 30% v/v DEHPA in Isopar-L. The strip solution was 500 mL of 2M sulfuric acid (H₂SO₄). The initial pH of the feed solution was adjusted to 2.9 using ammonium hydroxide (NH₄OH). To prevent the decrease in the extraction rate over time, ammonium hydroxide was intermittently added to the feed solution to maintain a pH range of 2.5 to 3.0 over the fourteen-hour run. DEHPA selectively extracted undesirable metals including Cu, Al, Fe, and Zn along with Mn while preventing the co-extraction of Co, Ni, and Li. In this example, 98% of Co, Ni, and Li in the original feed solution was retained. The changes in concentration of the metals in the feed solution and the strip solution are shown in FIG. 5. The strip solution contained negligible Co, Ni, and Li, typically less than 10 ppm of these critical elements. Subsequent separations included the separation of Co from Ni and Li using Cyanex 272 at a pH of 4.5-5.0. In the third stage, Ni was separated from Li using Cyanex 272 at a pH of 6.0-6.5. In all stages, the pH was continuously maintained at the desired set point by adding ammonium hydroxide using an automated dosing system. Finally, the metal sulfates were converted into metal nitrates, which is one of the desired forms for remanufacturing new lithium-ion batteries.

In these and other embodiments, membrane solvent extraction was demonstrated to recover high purity (99.5 to 99.9 wt. %) critical elements from spent lithium-ion batteries. Critical cathode materials including Co, Ni, and Li were selectively separated from undesired elements by an extractant immobilized in a porous membrane. The extractant DEHPA was shown to be selective to the critical cathode materials and separated Co, Ni, and Li in a single stage. Using hollow fiber modules, the system of the present invention provides a compact and modular configuration, achieving high extraction rates for desirable elements with low energy and cost requirements. Additionally, solvent and extractant requirements are low, thus eliminating the need for relatively large inventories and associated losses as compared to traditional solvent extraction.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method for the recycling of end-of-life lithium-ion batteries, the method comprising:
dissolving battery cathode material containing Li, Co, Ni, Al, and Cu, within an acid to form a feed solution;
providing a membrane module including a plurality of hollow fibers, the plurality of hollow fibers including a porous sidewall defining a lumen side spaced apart from a shell side;
wetting the porous sidewall of the plurality of hollow fibers with an organic phase, the organic phase including an extractant and an organic solvent, wherein the extractant includes di-(2-ethylhexyl)phosphoric acid (DEHPA);
performing membrane solvent extraction by moving the feed solution along one of the lumen side or the shell side of the plurality of hollow fibers and simultaneously moving a strip solution along the other of the lumen side or the shell side of the plurality of hollow fibers;
maintaining a pH of the feed solution within a predetermined range of between 2.5 and 3.0, inclusive, during membrane solvent extraction;
maintaining an acid concentration of the strip solution within a predetermined range of between 0.5M and 3.0M, inclusive, during membrane solvent extraction;
wherein wetting the porous sidewall of the plurality of hollow fibers with the organic phase is performed prior to moving the feed solution and moving the strip solution, and wherein the extractant in the porous sidewall continuously extracts Al and Cu from the feed solution for recovery by the strip solution while substantially rejecting Li, Co, and Ni.

2. The method of claim 1, wherein maintaining a pH of the feed solution includes intermittently introducing a buffer or a base to the feed solution.

3. The method of claim 1, wherein the strip solution includes 2.0M sulfuric acid.

4. The method of claim 1, wherein the organic phase includes a volume ratio of the extractant to the organic solvent of between 1:1 and 1:4.

5. The method of claim 1, wherein the plurality of hollow fibers are formed from a hydrophobic material.

6. The method of claim 1, wherein the plurality of hollow fibers define a mean pore size of between 0.01 to 0.5 μm.

7. The method of claim 1, wherein wetting the porous sidewall of the plurality of hollow fibers includes circulating the organic phase through the hollow fiber membrane module before the feed solution and the strip solution are directed through the membrane module.

8. The method of claim 1, wherein the concentration of Al and Cu in the strip solution increases linearly over time.

9. The method of claim 1, wherein the concentration of Al and Cu in the feed solution decreases linearly over time.

10. The method of claim 1, wherein the feed solution includes an initial concentration of Fe and Mn, and wherein the extractant continuously extracts Fe and Mn from the feed solution.

11. A system for the recovery of critical elements, comprising:
a feed reservoir including a first feed solution containing dissolved battery material including a concentration of Li, Co, Ni, Al, and Cu;
a membrane module including a plurality of hollow fibers each having a porous sidewall that is pre-wetted with an organic phase, the organic phase including an extractant and an organic solvent, wherein the extractant includes di-(2-ethylhexyl)phosphoric acid (DEHPA);
a strip reservoir in fluid communication with the membrane module and including a strip solution having Al and Cu extracted from the first feed solution;
wherein the membrane module selectively recovers Al and Cu from the first feed solution while substantially rejecting Li, Co, and Ni.

12. The system of claim 11, wherein the organic solvent is an isoparaffinic hydrocarbon solvent.

13. The system of claim 11, wherein the plurality of hollow fibers are formed from a hydrophobic material.

14. The system of claim 11, wherein the plurality of hollow fibers define a mean pore size of between 0.01 to 0.5 μm.

15. A method for the recovery of critical elements from lithium-ion battery black mass, the method comprising:
pre-wetting a plurality of hollow fibers with an organic phase, wherein the organic phase includes an extractant and an organic solvent, the extractant comprising di-(2-ethylhexyl)phosphoric acid (DEHPA);
continuously circulating a feed solution along one side of the hollow fibers while maintaining a pH of the feed solution between 2.5 and 3.0, wherein the feed solution comprises lithium-ion battery black mass dissolved in acid;
continuously circulating a strip solution along the opposite side of the hollow fibers while maintaining an acid concentration of the strip solution between 0.5M and 3.0M, wherein the extractant extracts undesired metals from the feed solution for recovery by the strip solution while substantially rejecting Li, Co, and Ni, and wherein continuously circulating a feed solution and continuously circulating a strip solution is performed simultaneously until a measured concentration of at least one of the undesired metals in the feed solution falls below a predetermined level.

16. The method of claim 15, wherein maintaining a pH of the feed solution includes intermittently introducing a buffer or a base to the feed solution.

17. The method of claim 15, wherein the strip solution includes 2.0M sulfuric acid.

18. The method of claim 15, wherein the organic phase includes a volume ratio of the extractant to the organic solvent of between 1:1 and 1:4.

19. The method of claim 15, wherein the plurality of hollow fibers are formed from a hydrophobic material.

20. The method of claim 15, wherein the undesired metals include at least one of Al, Fe, Cu, and Zn.
